(19) United States
(12) Patent Application Publication
(10) Pub. No.: US 2026/0037962 A1
(43) Pub. Date: Feb. 5, 2026

(54) NON-FUNGIBLE CRYPTO WALLET CREATION, WALLET FUNDING AND ON BLOCKCHAIN NFT PAYMENT PROCESSING UTILITY USING BIOMETRIC COPYRIGHT-AS-A-SERVICE AND PROVENANCE NETWORK

(71) Applicant: Taliware, Inc., San Diego, CA (US)

(72) Inventors: Tarik Tali, San Diego, CA (US); Hassan Zili, Belair (MA); Abdelhak Tali, Tangiers (MA)

(21) Appl. No.: 19/285,258

(22) Filed: Jul. 30, 2025

Related U.S. Application Data
(60) Provisional application No. 63/677,106, filed on Jul. 30, 2024.

(51) Int. Cl. G06Q 20/36; G06K 19/06; G06Q 20/38; G06Q 20/40

(52) U.S. Cl. CPC G06Q 20/3678; G06Q 20/389; G06Q 20/40145; G06K 19/06037; G06Q 2220/00

(57) ABSTRACT

A system for creating, transferring and managing digital assets is provided wherein a blockchain is configured to create an original digital asset as an NFT, and simultaneously, creating and authenticating the digital asset by linking the biometrics of the creator to the digital asset on the blockchain, wherein the NFTs are managed through a crypto wallet using cryptocurrency for at least the creation and transfer of the digital assets.

### RELATED APPLICATIONS

This application is claims priority to U.S. Patent Application Ser. No. 63/677,106 filed Jul. 30, 2024, titled “Non-Fungible Crypto Wallet Creation, Wallet Funding and on Blockchain NFT Payment Processing Utility Using Biometric Copyright-As-A-Service and Provenance Network” and which application is incorporated herein by reference in its entirety.

This application is related to U.S. patent application Ser. No. 18/911,216 filed Oct. 9, 2024, titled “Digital Asset Creation and Provenance Platform with Integrated Creator and Owner Biometric Authentication” and which application is incorporated herein by reference in its entirety.

U.S. patent application Ser. No. 18/911,216 claims priority to U.S. Patent Application Ser. No. 63/543,163 filed Oct. 9, 2023, titled “Digital Asset Creation and Provenance Platform with Integrated Creator and Owner Biometric Authentication” and which application is incorporated herein by reference in its entirety.

U.S. patent application Ser. No. 18/911,216 is a continuation in part of U.S. patent application Ser. No. 17/347,740 filed Jun. 15, 2021, titled “Communication Method Based Non-fungible Token Creation Platform with Integrated Creator Biometric Authentication” which published Nov. 18, 2021 as publication number 2021/0357489 and which application and publication is incorporated herein by reference in its entirety.

U.S. patent application Ser. No. 17/347,740 is a continuation in part of U.S. patent application Ser. No. 16/429,644 filed Jun. 3, 2019, titled “Method and Apparatus for Passive Authentication of an Individual's Geo-Location via a Communication Network and for User Authenticating Images, Video, Social Media Check In and Social Media Content” which published Nov. 21, 2019 as publication number 2019/0357049, and which issued as U.S. Pat. No. 11,039,314 and which application publication and patent are incorporated herein by reference in their entirety.

U.S. patent application Ser. No. 16/429,644 claims priority to U.S. Patent Application Ser. No. 62/679,041 filed Jun. 1, 2018, titled Method and Apparatus for Passive Authentication of an Individual's Geo-Location via a Communication Network and for User Authenticating Images and Video and Social Media Check In and Social Media Content and Applications Using the Same” which application is incorporated herein by reference in its entirety.

U.S. patent application Ser. No. 16/429,644 is a continuation in part of U.S. patent application Ser. No. 15/790,328 filed Oct. 23, 2017 titled “Method and System for Authenticating an Individual's Geolocation Via a Communications Network and Applications Using the Same” and which issued as U.S. Pat. No. 10,708,778 which application and patent are incorporated herein by reference in their entirety.

Application Ser. No. 15/790,328 is a continuation in part of U.S. patent application Ser. No. 14/699,460 filed Apr. 29, 2015 and which published Jan. 21, 2016 as United States Patent Application Publication Number 2016-0021535 and which issued as U.S. Pat. No. 9,801,058 on Oct. 24, 2017, which publication and patent are incorporated herein by reference in their entireties.

U.S. patent application Ser. No. 14/699,460 claims priority to U.S. Patent Application Ser. No. 61/985,693 filed Apr. 29, 2014, titled “Method and System for Accessing, Acquiring, Storing and Managing each Individual's Geo-Location Position Data via a Communication Network Providing an Internet of Things Geo-Location Software Management Utility” which application is incorporated herein by reference in its entirety.

### BACKGROUND INFORMATION

### 1. Field of the Invention

The present invention relates to enhanced crypto wallet creation, wallet funding and on blockchain NFT payment processing utility.

### 2. Background Information

### Non-Fungible Tokens

Non-fungible tokens, or NFTs, are cryptographic assets on blockchain with unique identification codes and metadata that distinguish them from each other. Alternatively, an NFT may be defined as a unit of data stored on a digital ledger, called a blockchain that certifies a digital asset to be unique and therefore not interchangeable.

Unlike cryptocurrencies, NFTs cannot be traded or exchanged at equivalency. The distinct construction of each NFT has been recognized has having great potential for several use cases, including digital artwork. NFTs involving digital art generally do not store the file on the blockchain due to its size. The token functions in a way more similar to a certificate of ownership, with a web address pointing to the piece of art in question. Further, because they are based on blockchains, NFTs can also be used to remove intermediaries in the sales chain and connect artists with audiences, or for identity management. NFTs can remove intermediaries, simplify transactions, and create new markets. NFTs can often also contain ownership details for easy identification and transfer between token holders. Owners can also add metadata or attributes pertaining to the asset in NFTs. For example, artists can sign their digital artwork with their own signature in the metadata.

NFTs evolved from the ERC-721 standard which defines the minimum interface—ownership details, security, and metadata—required for exchange and distribution of gaming tokens. The ERC-1155 standard takes the concept further by reducing the transaction and storage costs required for NFTs and batching multiple types of non-fungible tokens into a single contract. The FLOW blockchain, which uses proof of stake consensus model, supports NFTs. For example NBA Top Shot is run on the FLOW blockchain. Tezos is a blockchain network that operates on proof of stake and supports the sale of NFT art.

One of the most famous use case or example for NFTs is that of cryptokitties. Launched in November 2017, cryptokitties are digital representations of cats with unique identifications on an Ethereum blockchain. Each kitty is unique and has a price in Ether. They reproduce among themselves and produce new offspring, which have different attributes and valuations as compared to their parents.

Non-fungible tokens are an evolution over the relatively simple concept of cryptocurrencies. As another example, digital artwork entitled “Everydays—The First 5000 Days”, by artist Mike Winkelmann, also known as Beeple, sold for US$69.3 million in 2021. Another Beeple piece entitled “Crossroad”, consisting of a 10-second video showing animated pedestrians walking past a figure of Donald J. Trump, sold for US$6.6 million at Nifty Gateway, an online cryptocurrency marketplace for digital art.

Blockchain and the technology enabling the network have given the opportunity for musicians to tokenize and publish their work as non-fungible tokens. This has extended the list of options for musicians and artists alike to monetize and profit from their music as well as other content surrounding the themes of the music and the artist's public image. Additionally, NFTs have provided the opportunity for artists and touring musicians to recover lost income due to the 2020 COVID-19 pandemic which resulted in music industry revenues to fall nearly 85%. Similar to limited edition merchandise, or a physical copy of an artist's work, NFTs allow more avenues for fans to connect with, and support their favorite bands or artists. NFTs were extremely influential to the music industry within 2021 where many artists across all genres explored the usage of NFTs in their streams of revenue.

In February 2021 alone, NFTs reportedly generated around $25 million within the music industry leading to increased ventures in the medium by more artists. On Feb. 28, 2021, electronic dance musician 3LAU sold a collection of 33 NFTs for a total of $11.7 million to commemorate the three-year anniversary of his Ultraviolet album. On Mar. 3, 2021, rock band Kings of Leon became the first to announce the release of a new album, When You See Yourself, in the form of an NFT. The NFT went on to generate a reported $2 million in sales, in which more than quarter of the revenue was donated to charity benefiting live entertainment workers. Later the same month, American rapper Lil Pump partnered with the NFT platform Sweet, to release a special NFT collection. Record producer Mike Dean united with artist Shepard Fairey to release their NFT collection OBEY 4:22 on Apr. 23, 2021. On Apr. 25, 2021, rapper and producer Eminem released original instrumental beats and other collectables as an NFT collection, titled ShadyCon.

In a Mar. 27, 2021, Saturday Night Live episode, cast members satirized this growing NFT niche with a comedy skit on NFTs, which skit was later sold in the form of an NFT for $365,000 on Apr. 6, 2021. Even the patent world is not immune from the commercialization opportunities of NFTs. In May 2021, UC Berkeley announced that it would be auctioning NFTs for the patent disclosure documents (invention disclosure forms filled out by university inventors) for two Nobel Prize-winning inventions: CRISPR-Cas9 gene editing and cancer immunotherapy.

Currently blockchains may be categorized as two layers or types of blockchains, Layer 1 blockchain and Layer 2 blockchain. Layer 1 blockchain is best represented by BITCOIN, ETHERIUM, CARDANO, XRP, and a few others. Layer 2 blockchains may be categorized as typically using Layer 1 blockchains to run their applications/Technology innovations. Solana, the largest NFT marketplace, runs on Layer 1 of the Ethereum blockchain.

The individualized or unique aspect and authenticating protocols of NFTs make them well suited for digital artwork as outlined above, however there is still a need to provide authentication of authorship at the point of the NFT creation and to have this accomplished in an automated fashion and to facilitate the marketability of NFTs. Additionally there is a need to verify changes in ownership of NFT's and digital assets in general.

### SUMMARY OF THE INVENTION

One aspect of this invention is directed to a cost effective, efficient, method and system for authenticating, accessing, acquiring, storing, transferring and managing digital assets wherein an L2 blockchain is manifested by the platform of the invention in creating the original copy of a digital asset such as an NFT, at the same time, creating and authenticating the digital rights of that digital asset by linking or fusing the biometrics of the creator/author and/or the owner to the digital asset and the data/metadata is written as an alibi on the blockchain to be access at anytime from anywhere via a token, wherein this process may occur simultaneously during the creation of the digital asset token. The platform of the present invention may be viewed as a layer 2 blockchain system using a system such as the POLYGON system for data transfer. This process is to be commercialized under the brand name CRYPTOCOPYGRAPHY™ by the applicant Taliware. Further the present invention creates a crypto wallet for the user automatically with means for funding and managing digital assets via the crypto wallet.

One aspect of the present invention provides a system for creating, transferring and managing digital assets wherein an blockchain is configured to create an original digital asset as an NFT, and simultaneously, creating and authenticating the digital asset by linking the biometrics of the creator to the digital asset on the blockchain, wherein the NFTs are managed through a crypto wallet using cryptocurrency for at least the creation and transfer of the digital assets.

One aspect of the invention provides a system for creating, transferring and managing digital assets wherein a blockchain is configured to create an original digital asset as an NFT, and simultaneously, creating and authenticating the digital asset by linking the biometrics of the creator to the digital asset on the blockchain, wherein the system is configured for embedding of a QR code directly onto an authenticated NFT, wherein when scanned, this QR code directs the user to a dedicated web portal.

One aspect of the invention provides a system for creating, transferring and managing digital assets wherein a blockchain is configured to create an original digital asset as an NFT, and simultaneously, creating and authenticating the digital asset by linking the biometrics of the creator to the digital asset on the blockchain, wherein the system is configured to incorporate Invisible Watermarks integrated into the NFT.

The communication network based method of one aspect of the invention provides wherein the associated blockchain implements a token issuance schema and wherein the digital data files include at least one of audio, video, and image files, and wherein the step of recording the individual's authentication data includes the steps of recording the individual's authentication data off of the associated blockchain and recording hashes of the recorded data on the associated blockchain. The communication network based method of one aspect of the invention may provide wherein the step of recording the individual's authentication data off of the associated blockchain is on the cloud. The communication network based method of one aspect of the invention may provide wherein the associated blockchain implements a token issuance schema and wherein the digital data files include at least one of audio, video, image files and document files.

### BRIEF DESCRIPTION OF THE FIGURES

FIG. 1 is a schematic representation of a non-fungible crypto wallet creation, wallet funding and on blockchain NFT payment processing utility using biometric copyright-as-a-service and provenance network according to one aspect of the invention;

FIG. 2 is a schematic representation of the creation of an NFT with optional QR Code and/or watermark for increased traceability and security.

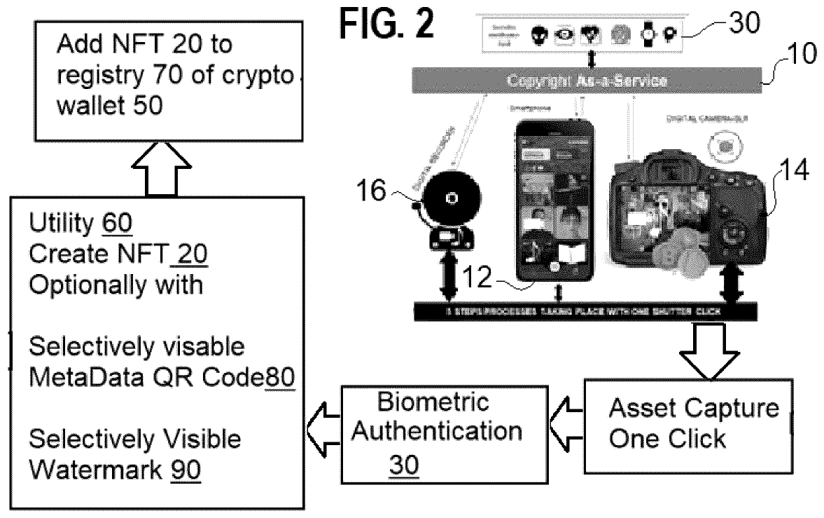

### BRIEF DESCRIPTION OF THE PREFERRED EMBODIMENTS

As discussed above the present invention relates to and builds upon user geo-location software and also to an on the blockchain geo-locations software management utility. Specifically the present invention provides a method and system for storing an individual's geo-location via a communication network, and may further include incorporation into a private blockchain network, and applications using the same. The details and operation of private blockchain networks are known in general in the art. The revolutionary aspects of blockchain technology is commonly being touted, but they still suffer from the “garbage in-garbage out” problem.

The application of, or incorporation of, user geo-location software of the present invention with a blockchain network is further detailed in U.S. Publications 2016-0021535, 2019/0357049, 2020/0329018, 2021/0357489 and WO/2019-126471, and in U.S. Pat. Nos. 9,801,058, 10,708,778, and 11,039,314, which publications and patents are incorporated herein by reference, and this helps verify user inputs into a blockchain network. The present application builds upon these disclosures, some of which is appended below for clarification.

One aspect of this invention is directed to a cost effective, efficient, method and system for authenticating, accessing, acquiring, storing, transferring and managing digital assets wherein an L2 blockchain is manifested by the platform of the invention in creating the original copy of a digital asset such as an NFT, at the same time, creating and authenticating the digital rights of that digital asset by linking or fusing the biometrics of the creator/author and/or the owner to the digital asset and the data/metadata is written as an alibi on the blockchain to be access at anytime from anywhere via a token, wherein this process may occur simultaneously during the creation of the digital asset token. The platform of the present invention may be viewed as a layer 2 blockchain system using a system such as the POLYGON system for data transfer. This process is to be commercialized under the brand name CRYPTOCOPYGRAPHY™ by the applicant Taliware. Further the present invention creates a crypto wallet for the user automatically with means for funding and managing digital assets via the crypto wallet.

The communication network based method of one aspect of the invention provides wherein the associated blockchain implements a token issuance schema and wherein the digital data files include at least one of audio, video, and image files, and wherein the step of recording the individual's authentication data includes the steps of recording the individual's authentication data off of the associated blockchain and recording hashes of the recorded data on the associated blockchain. The communication network based method of one aspect of the invention may provide wherein the step of recording the individual's authentication data off of the associated blockchain is on the cloud. The communication network based method of one aspect of the invention may provide wherein the associated blockchain implements a token issuance schema and wherein the digital data files include at least one of audio, video, image files and document files.

As detailed below the NFT 20 managed within the crypto wallet 50 of the invention via a registry 70 and or the cryptocurrency/Bitcoin managed by the wallet utility 50 may be transfer from one device/Wallet 50 to another device/Wallet 50 using just a Bluetooth mesh network, not cellular network. Another aspect of the invention provides for seller and buyer to biometrically perform ‘accept/purchase and release/sell’ for the authorization of an NFT transfer through mobile device biometrics.

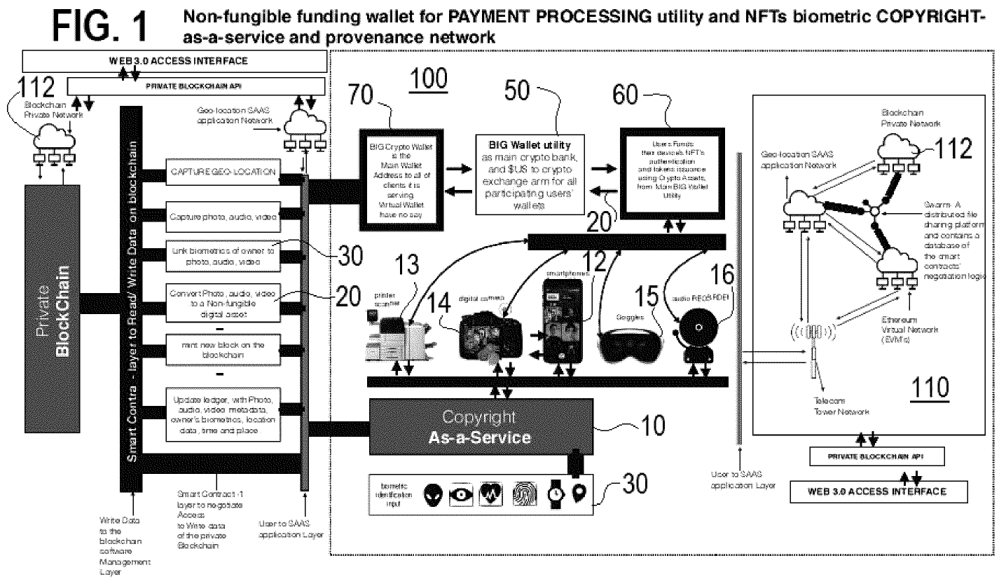

One aspect of the present improvement is forming a platform 100 that, at a high level, creates an authenticator as a service for digital assets as schematically represented in FIG. 1. The application programming interface (API) is a way for two or more computer programs to communicate with each other. The platform 100 schematically shown in FIG. 1 offers a diverse range of API endpoints. The users are empowered to interact a Copyright branch 10 of the platform 100.

Within this patent application, and the application 100, the term copyright will be representative of or related to the digital rights granted to digital assets, including but not limited to rights under US or other jurisdictions copyright laws. It is important to note that in the United States, and many jurisdictions, the legal copyright protection attaches as soon as the work is fixed in tangible form. In the US 17 U.S.C. § 101 defines a work is “created” when it is fixed in a copy . . . for the first time and 17 U.S.C. § 102 noted that “copyright protection subsists, in accordance with this title, in original works of authorship fixed in any tangible medium of expression, now known or later developed, from which they can be perceived, reproduced, or otherwise communicated, either directly or with the aid of a machine or device.”

The copyright 10 side of the platform 100 adds authentication to the creation or to the transfer of digital assets 20, which is discussed further below. When digital assets 20 are created, or transferred, biometric authentication 30 is used to verify authenticity and firmly establish transfer in ownership.

The platform 100 of the present invention would be and is commonly used and easily understood with photographs taken by the user on his phone 12, digital camera 14 or other digital visual artwork created by a user, which digital art sources (see examples 12-16) are important sources of digital asset creation in today's marketplace. However, the platform 100 is not limited to visual works, for example, the platform 100 may be used with music NFTs from audio creation source 16 which also have also become popular in a short amount of time. It is very easy for music creators to mint their work with this platform 100. The platform 100 may be effectively used for NFTs 20 in event ticketing, and the platform 100 yields improved security via the owner authentication aspects of the platform 100. The platform 100 of the present invention could also be used in NFT's 20 associated with “Venue and musician/artist collaboration” similar to event ticketing. Venues and musicians/artist could collaborate on unique NFTs 20 that both grant admission to the show but also give concert/event goers perks and extras like exclusive artwork or access to other merchandise. With this platform 100, venues and artists could keep more money and exert more control over the ticketing process as well as offer enhanced security benefits to the users. The event ticketing and the venue/artist collaboration aspects would both likely expect the users to retain the NFT 20 beyond a given event.

The platform 100 present invention includes a systems and method of a communications network, a private blockchain network 112 and a token issuance schema (schematically shown at 110) that grants access to the private blockchain network' data-as-a-service. The blockchain application or implementation is critical in the NFT creation aspects of the present invention. This invention provides a cost effective, efficient, system for a write-a private blockchain network to write-to and read-from the individual's authenticated data, with smart contracts issuing a token This invention is directed to a cost effective digital rights management (DRM), efficient on the blockchain monetization of the stored authenticated records. For example of the individual who actually captured the photo via smartphone and further including records of the captured photo such as the place the picture was taken, time the picture was taken, etc.

The present invention is directed to a cost effective, efficient incorporation into a blockchain data storage and security. As noted above a non-fungible asset (NFT) 20 is a type of cryptographic token on a blockchain that represents a single asset. These can be fully digital assets or tokenized versions of real world assets. Since NFTs 20 are not interchangeable with each other, they can function as proof of authenticity and ownership within the digital realm. Fungible means that the individual units of an asset are interchangeable and essentially indistinguishable from one another. For example, fiat currencies are fungible, because each unit is exchangeable for any other equivalent individual unit. A ten-dollar bill is interchangeable with any other ten-dollar bill that is authentic.

A “one click to artwork” conversion to a digital asset in the form of a Non-FungibleToken or NFT 20 describes a process by which the individual's artwork and or assets: The individual's location, the biometrically authenticated Images, Video, data, audio and Social Media Content and applications who are then processed and converted to digital asset 20 on the blockchain and a Token is issued.

In the invention when a user turn a dataset such as an image into an NFT 20 generally the artwork itself does not get stored in the Blockchain. Rather an entry in the blockchain gets created with the help of smart contracts and within its metadata only consists of a short description of the individual's biometrics unique ECG information, the individual's geo-location data, the image captured, the video captured, the audio captured and something as simple as a link that refers to a place in the web where the actuate artwork data is stored.

The One-Click process describes the method and system for an individual to biometrically authenticate at the instance of capturing their artwork and or assets (collectively digital data files) referred to here as the individual's location captured by the cellular GPS, the image taken, the video, the printer document, the scanned document, the photocopied document, the newly created document and or the audio captured INTO authenticated digital assets (e.g. the digital files) wrapped around an issued token on the blockchain using only one-touch or one click of the smartphone capture button.

The following describes the multi-event that takes place when the individual touches their smartphones button, digital camera button, printer/scanner/copier button, and or to open new MAC WORD file, ADOBE PHOTOSHOP file or MICROSOFT WORD file document using mouse or pad button to capture their (artwork); the multi-event describes the: Capture of the artwork, the authentication of the artwork, the conversion of the artwork into asset into a digital asset, the issuance of a token to wrap the artwork into a NON-Fungible (NFT) 20 all happening in one single instance; one single click or trigger and or activation of the smartphone capture button. The Multi-event describes the simultaneous capture of the artwork and the activation of the device with a biometric component such as a smartphone 12 biometric finger scanner, printer/scanner/copier 13 biometric button and/or via goggles 15 with integrated Facial Identification/Iris based biometric with embedded cellular, camera and storage in combination with hand gesture to perform the artwork capture, the artwork authentication simultaneously linking the artwork captured to the individual who took it; while at the same time, generating a token and wrapping the artwork captured and its related data around it into digital assets available on the blockchain. The One-Click process converting artwork into digital assets and into an (NFT) 20 using a wearable enabled with ECG biometrics—as detailed above is then used as the same process definition applied in the finger scan passive biometrics function to create an artwork (NFT). The same One-Click process converting an Artwork into an (NFT) using Facial biometrics may be applied here.

The present invention provides the individual with a biometric user identification technology coupled to the smartphone; where the smartphone touch-id button, the touch-id button has a built-in fingerprint scanner mechanism, this fingerprint scanner mechanism is activated simultaneously during the click/touch button in a multi-event to take image, audio, video, printer/scanned/copied document and or newly created word file document and or ADOBE PHOTOSHOP document and at the same time to scan the fingerprint biometrics of the individual. Therefore, the take image, audio, video, printer/scanned/copied document and or newly created WORD file document and or ADOBE PHOTOSHOP document are biometrically authenticated and has all the data authentication associated with it—Location, the individual's fingerprint, the date stamped and the image marker. The image is then recorded on the private blockchain with its associated authentication data and becomes a ONE-CLICK AUTHENTICATED-NFT. The same event and process takes place when providing the individual with an ECG biometric user identification technology coupled to the smartphone. The same event and process takes place when providing the individual with a Facial Identification/Iris based biometric user identification technology coupled to the smartphone.

The integration of the platform 100 with a marketplace for the digital works with digital asset management of the biometric authenticated works of the present invention is shown in FIG. 1. Here it is shown that phones 12, digital cameras 14, printer/scanner and/or copier 13 and or goggles 15 with integrated Facial Identification/Iris based biometric with embedded cellular, camera and storage, or audio creation device 16 with biometric scanning element may be used within the platform 100 for one-click creation of the NFT 20 with biometric authentication data 30.

Digital assets may be prepared on other devices than those shown working on the platform 100 provides that the biometric data 30 may be incorporated with the created digital asset with one click. It is also anticipated that a given users biometrics may be verified from or checked with a biometrics database on file, with the system 100 noting where the source of the biometrics was obtained. The database may be utilized to add alternative biometrics of authorized owners or users to an NFT 20. The use of a biometric database may be particularly useful in governmental and corporate implementations.

The key aspect of the invention may be described as providing a Non-fungible Crypto Wallet Creation, Wallet Funding and on Blockchain NFT PAYMENT PROCESSING utility 50 using biometric COPYRIGHT-as-a-service and provenance network 10. The crypto wallet utility 50 of the present invention incorporates digital assets 20 in a registry 70 with more conventional aspects of a crypto wallet (housing crypto assets of the user) with improved funding options through utility 60 for the user and is referenced by the applicant as a Big Wallet Utility 50 (which includes the registry 70 and funding utility 60). The crypto wallet 50 is, in part, an asset registry 60 of non-fungible digital assets and separately will allows for easy integration with others Crypto exchange platform virtual wallets that belong to the user. The crypto wallet 50 of the invention preferably also allows users to pull in other digital assets into the registry 70 with a one click utility and couple biometric data to the associated digital asset.

The system 100 automatically forms the crypto wallet utility 50 with asset registry 70 and funding utility 60 for a user. The funding utility 60 allows the user to fund the crypto wallet utility 50 with whatever currency desired and the system 100 will automatically convert to the desired cryptocurrency of the platform 100. Further the funding utility 60 of the created crypto wallet 50 is directly associated with the capture of a digital asset 20 with biometric authentication. In other words the utility 60 will debit the user account to pay for the creation of a digital asset 20 with bio authentication 30 from an associated device 12-16. The user essentially funds the NFT authentication and token issuing that creates the asset 20 with bio authentication 30 using crypto assets from a main crypto Wallet Utility 50 that is acting as their central crypto bank. All payment issuance for each client's virtual wallet is from the Crypto Wallet utility 50 acting as the main crypto wallet of the user.

The crypto wallet utility 50, as mentioned above, is a broader version of a crypto wallet. Unlike a normal wallet, which can hold actual cash, crypto wallets store a person's access to cryptocurrencies. Crypto wallets technically don't store a person's crypto as a person's holdings live on the blockchain, but can be accessed using a private key. A persons crypto keys prove your ownership of their digital money and allows them to make transactions. The crypto wallet utility 50 referenced herein further allows access to and management of all the digital assets 20 created herein, and funding of the creation of the digital assets 20 as well as conventional access to crypto currencies.

The crypto wallet utility 50 provides a simple method for a user to create and fund a digital wallet that is also associated with their asset creating devices (e.g., smartphones 12, digital camera 14, Wearable Goggles 15, digital audio recorder 16, digital scanner or digital printer 13) at the instance of on blockchain payment processing in order to complete a digital asset to NFT conversion (asset 20 creation) during a photo capture, audio, video, print or scan capture using such a device (e.g., a smartphone 12, a digital camera 14, wearable goggles 15, audio recorder 16, video recorder printer and scanner 13) with all communicating crypto payment via funding utility 60 to the blockchain in use, using the biometric authentication and payment processing utility 60.

The system 100 creates a crypto wallet utility 50 which can assume the position of the person's main crypto bank, or a person's central crypto bank out of which all the users' crypto payment processing may be issued.

The user's asset creating devices (e.g., a smartphone 12, a digital camera 14, wearable goggles 15, audio recorder 16, video recorder printer and scanner 13) are coupled to their crypto wallet 50, which will be, in part, a virtual wallet, and it will be created automatically by the system 100. Thus each user will have a virtual wallet that holds the balance or the amount of crypto assets they currently hold.

The system 100 adds an important traceability and authenticating elements to the NFT 20 formed in the present invention. Specifically the system 100 allows for QR Codes 80 and/or Invisible Watermarks 90 to be integrated into the NFT 20 (assuming the user elects to use the system 100 to form the NFT 20) for Enhanced Traceability, Tradeshow Engagement, and Search Engine Optimization. A QR code 80 references a “quick-response code, is a type of two-dimensional matrix barcode invented in 1994. Typically, a common use of a QR code is that a smartphone or analogous device is used as a QR code scanner, displaying the code and converting it to some useful form, such as a standard URL for a website. The system 100 facilitates the embedding of a QR code directly onto an authenticated NFT's visual representation (image or video) or within an associated document. When scanned, this QR code directs the user to a dedicated web portal. This portal serves as a comprehensive source for the relevant metadata of the NFT 20, providing detailed information such as: Current owner's identity; Image/video specifics: Original capture location, creator, and other relevant details, or Commercial status: Availability for sale and asking price. This feature significantly enhances the traceability and transparency of digital assets 20, offering a streamlined way to verify an NFT's provenance and associated information.

Additionally, at events like tradeshows, users equipped with Meta's AI-driven Ray-Ban glasses (or analogous technologies) can seamlessly scan these QR codes 80 on images or videos of the NFT 20. This allows them to instantly view the associated metadata, offering an immersive and interactive way to engage with digital assets 20 of the system 100. Furthermore, for Google search engine operators utilizing image search functionalities, the presence of QR-coded images in the NFT 20 provides a significant advantage. It allows them to access richer metadata directly from the image, including detailed information about its content and, importantly, its owner. This enhances content discoverability and provides deeper context for digital assets 20 found through search.

Optionally the system 100 allows for Invisible Watermarks 90 to be integrated into the NFT 20 to combat copyright infringement. The system 100 incorporates methods for applying a selectively invisible watermark to authenticated images, videos, and documents of NFT 20. This discreet mark serves as a robust deterrent against unauthorized reproduction. Moreover, a dedicated utility (part of crypto wallet 50) is provided to render this invisible watermark 90 visible when necessary, particularly in the context of legal disputes concerning copyright infringement or analogous disputes. This capability offers irrefutable evidence of ownership and authenticity, strengthening legal recourse against unauthorized use.

As a further safety aspect provided by the present system 100 one can use the system 100 to create an authenticated facial/voice and/or body identity that will yield some protection against the creation of deep AI fakes. In other words the system 100 can be used to create a master proof of a given user's features that are authenticated by their biometrics and this standard be used to debunk/dismiss/remove deep fakes.

The payment utility 60 of the system 100 provides a simple mechanism for all users to fund their wallets 50 without involving the user involvement in the creation and managing of their crypto wallet, as it's considered a complex process and one must be computer savvy in order to complete this crypto wallet creation process. The system 100 provides a simple Crypto Funding process of the user's Crypto Wallet 50 by simply funding their Crypto wallet 50 using the mainstream and commonly used payment process, like ApplePay, Google Pay, PayPal and ECT. All the user has to do is to purchase or fund their Crypto Wallet 50 using $ dollars (or desired currency) through the associated wallet utility 60's simple request. Users then select the amount of US dollars (or desired currency) they wish to deposit to their crypto Wallet 50 via their smartphones using Apple Pay, Google Pay, PayPal and various other payment methods. The system wallet utility 60 acting as a central crypto bank will then convert the tendered user's US dollar amount in the corresponding cryptocurrency at the exchange rate at the instance. The system wallet utility in this case may be using Polygon Matics, as a cryptocurrency.

The Crypto Wallet 50 will then show the amount of Cryptocurrency (or Matics) balance they have now available to them that the system's wallet utility 50 has made available to them. The user can then proceed to capture, record, print, or scan using blockchain biometric authentication, and the crypto payment associated with each processing from using the blockchain network will be deducted from their Crypto Wallet 50. When the Crypto Funds are depleted, the user will be asked to fund their account before proceeding with another blockchain biometric authentication event. Each time the user performs a new token issuance to secure their digital assets, the wallet utility 50 deducts the crypto fees needed for the user blockchain network to process their request.

The system 100 simplifies the user's crypto wallet 50 creation. The user does not have to create a crypto wallet 50, the system 100, a blockchain payment processing utility will create one for them automatically and will hold their crypto asset as balance available to use and or spend. Users simply fund their Crypto Wallets 50 using mainstream available payment methods, like Apple-Pay, Pay-Pal, Google-Pay ETC

### Big Wallet Utility 50 as Main NFTs Validation Warehouse to all Clients.

Since Crypto Wallet utility 50 is main crypto and exchange wallet serving all of the users, in issuing their tokens to securing all their digital assets—NFTs 20 on the blockchain, automatically renders the Crypto Wallet utility 50 address as the Wallet address to all clients during their NFT's validation and their NFTs proof-of-ownerships. The Crypto Wallet 50 as the main Tokens issuer to all of the client's virtual wallet will be the main Wallet address to each of its clients. Each NFT look up table or registry 70 will have a hashing with wallet address of the Crypto Wallet 50. For example, in the case of a SONY brand Camera, the hash of the token of all its clients' NFT's 20 will have the SONY Wallet address then followed by the clients NFT metadata (including biometrics 30) like fingerprint biometric data, location of photo where it was taken, Time Stamp, Price of the Photo, Size of Photo and other data as prescribed during initiation. Naturally it is the same, if it's a CANON Camera, Nikon, Apple iphone, Samsung smartphone, GoPro Camera, HP printers and Scanner, Xerox Printers. All of these devices associated NFTs 20 on the blockchain will have Canon, Nikon, Apple, Samsung, GoPro, HP, Xerox as the Main Crypto wallet address in the hashing table. Then followed by the clients NFT's metadata. This then makes each Crypto Wallet by these entities through this system for Canon, Nikon, Apple, Samsung, GoPro, HP, Xerox, ECT to become as the as main NFTs Validation Warehouse to all of their clients generated NFT's throughout the blockchain network.

As described above the invention may be described as a non-fungible crypto wallet creation, wallet funding and on blockchain NFT payment processing utility using biometric copyright-as-a-service and provenance network. The system may be described as a Crypto Concierge API which acts to: Allow Users' Crypto Wallets Creation; Provides Automatic Smart Contract creation; Provides One Click Photo to NFT Creation; Provides $ US to Cryptocurrency Exchange; Becomes central wallet managing all users funds/act like central bank; Issues Provenance Tokens; this system introduces innovative methods for bolstering the authenticity and protecting the copyright of NFT-backed digital assets, including images, videos, and documents; the system includes QR codes for enhanced tracability. We must claim one touch copyright: One touch performs multi-touch-functions in “biometric NFT creation”: Scans biometrics, captures image/voice/video/files/docs and converts into authenticated non-fungible digital assets all at once.

Another aspect of the system 100 is the system 100 can “biometrically approve” the release of an NFT 20 to a market place/seller through smartphone/digital device (12-16) biometrics due to the authentication aspects 30. As with any transfer, the ledger 70 is updated with new owner and the like. Other aspects of the system 100 described above include Device-to-device via BlueTooth mesh network crypto/NFT and payment transfer The system further anticipates off-chain crypto data storage followed by syncing when online, which can use this approach: Encrypted Local Storage—Store data securely on-device using AES encryption; Merkle Tree Snapshots—Structure data off-chain with Merkle trees to ensure integrity; ZK Proofs or Signatures—Generate zero-knowledge proofs or cryptographic signatures for later on-chain verification. Deferred Commit Protocol—When online, push data hashes or proofs to the blockchain via a commit-reveal or time stamped batch transaction. The above process ensures tamper-proof, private storage that syncs seamlessly when connectivity resumes.

It is apparent that many variations to the present invention may be made without departing from the spirit and scope of the invention.

What is claimed is:

1. A system for creating, transferring and managing digital assets wherein a blockchain is configured to create an original digital asset as an NFT, and simultaneously, creating and authenticating the digital asset by linking the biometrics of the creator to the digital asset on the blockchain, wherein the NFTs are managed through a crypto wallet using cryptocurrency for at least the creation and transfer of the digital assets.

2. The system for creating, transferring and managing digital assets according to claim 1, wherein the system is configured for the user to fund the crypto wallet with a first currency and the system automatically converts the submitted first currency to a cryptocurrency of the system.

3. The system for creating, transferring and managing digital assets according to claim 2, wherein the system is configured to debit the user account to pay for the creation of a digital asset with bio authentication from an associated digital asset creating device.

4. The system for creating, transferring and managing digital assets according to claim 3, wherein each associated digital asset creating device is configured to create the digital asset via a single activation of the user.

5. The system for creating, transferring and managing digital assets according to claim 1, wherein the system is configured to create a crypto wallet for a user automatically and will hold their crypto assets as balance therein available to use and or spend.

6. The system for creating, transferring and managing digital assets according to claim 5, wherein the system is configured to allow users to fund their crypto wallets using mainstream available payment methods in currencies other than the cryptocurrency of the system.

7. The system for creating, transferring and managing digital assets according to claim 1, wherein the system is configured to allows for QR Codes to be integrated into the NFT.

8. The system for creating, transferring and managing digital assets according to claim 7, wherein system is configured for embedding of a QR code directly onto an authenticated NFT, wherein when scanned, this QR code directs the user to a dedicated web portal.

9. The system for creating, transferring and managing digital assets according to claim 8, wherein the QR code directed web portal serves as a comprehensive source for the relevant metadata of the NFT.

10. The system for creating, transferring and managing digital assets according to claim 9, wherein the QR code directed web portal includes detailed information including at least some of Current owner's identity; Image/video specifics: Original capture location, creator, and Commercial status.

11. The system for creating, transferring and managing digital assets according to claim 7, wherein the QR codes are viewable at all times with specialized equipment.

12. The system for creating, transferring and managing digital assets according to claim 1, wherein the system is configured to incorporate Invisible Watermarks integrated into the NFT.

13. A system for creating, transferring and managing digital assets wherein a blockchain is configured to create an original digital asset as an NFT, and simultaneously, creating and authenticating the digital asset by linking the biometrics of the creator to the digital asset on the blockchain, wherein the system is configured for embedding of a QR code directly onto an authenticated NFT, wherein when scanned, this QR code directs the user to a dedicated web portal.

14. The system for creating, transferring and managing digital assets according to claim 13, wherein the NFTs are managed through a crypto wallet using cryptocurrency for at least the creation and transfer of the digital assets.

15. The system for creating, transferring and managing digital assets according to claim 13, wherein the system is configured for the user to fund the crypto wallet with a first currency and the system automatically converts the submitted first currency to a cryptocurrency of the system.

16. The system for creating, transferring and managing digital assets according to claim 15, wherein the system is configured to debit the user account to pay for the creation of a digital asset with bio authentication from an associated digital asset creating device.

17. A system for creating, transferring and managing digital assets wherein a blockchain is configured to create an original digital asset as an NFT, and simultaneously, creating and authenticating the digital asset by linking the biometrics of the creator to the digital asset on the blockchain, wherein the system is configured to incorporate Invisible Watermarks integrated into the NFT.

18. The system for creating, transferring and managing digital assets according to claim 17, wherein the NFTs are managed through a crypto wallet using cryptocurrency for at least the creation and transfer of the digital assets.

19. The system for creating, transferring and managing digital assets according to claim 18, wherein the system is configured for the user to fund the crypto wallet with a first currency and the system automatically converts the submitted first currency to a cryptocurrency of the system.

20. The system for creating, transferring and managing digital assets according to claim 17, wherein the system is configured to allows for QR Codes to be integrated into the NFT.
